(19) United States
(12) Patent Application Publication
(10) Pub. No.: US 2009/0039562 A1
(43) Pub. Date: Feb. 12, 2009

(54) Method for producing an anti-scatter grid or collimator made from absorbing material

(76) Inventors: Andreas Freund, Heroldsbach (DE); Bjoern Heismann, Erlangen (DE); Harald Maerkl, Gerhardshofen (DE); Martin Schaefer, Duesseldorf (DE); Thomas Von Der Haar, Nuernberg (DE)

Correspondence Address: HARNESS, DICKEY & PIERCE, P.L.C., P.O.BOX 8910, RESTON, VA, 20195, US

(21) Appl. No.: 12/285,055

(22) Filed: Sep. 29, 2008

Related U.S. Application Data
(62) Division of application No. 11/142,190, filed on Jun. 2, 2005.

(30) Foreign Application Priority Data
Jun. 3, 2004 (DE) 10 2004 027 158.5

(51) Int. Cl. B29C 35/08

(52) U.S. Cl. 264/434

(57) ABSTRACT

A method is proposed for producing an anti-scatter grid or collimator for a radiation type, which is formed from at least one base body of prescribable geometry having transmission channels or slits for primary radiation of the radiation type which extend between two opposite surfaces of the base body. The base body is formed from a structural material that strongly absorbs the radiation type, either using the injection molding technique or by way of the technique of stereolithography. The method can be used to produce an anti-scatter grid or collimator with high accuracy and with the aid of only a few steps.

The present application hereby claims priority under 35 U.S.C. §119 on German patent application number DE 10 2004 027 158.5 filed Jun. 3, 2004, the entire contents of which is hereby incorporated herein by reference.

### FIELD

The present invention generally relates to a method for producing an anti-scatter grid or collimator for a radiation type. Specifically, it relates to one which is formed from at least one base body of prescribable geometry having transmission channels or transmission slits for primary radiation of the radiation type which extend between two opposite surfaces of the base body.

### BACKGROUND

In radiography, stringent requirements are currently placed on the image quality of the x-ray images. In such images, as are taken especially in medical x-ray diagnosis, an object to be studied is exposed to x-radiation from an approximately point radiation source, and the attenuation distribution of the x-radiation is registered two-dimensionally on the opposite side of the object from the x-ray source. Line-by-line acquisition of the x-radiation attenuated by the object can also be carried out, for example in computed tomography systems.

Besides x-ray films and gas detectors, solid-state detectors are being used increasingly as x-ray detectors, these generally having a matricial arrangement of optoelectronic semiconductor components as photoelectric receivers. Each pixel of the x-ray image should ideally correspond to the attenuation of the x-radiation by the object on a straight axis from the point x-ray source to the position on the detector surface corresponding to the pixel. X-rays which strike the x-ray detector from the point x-ray source in a straight line on this axis are referred to as primary beams.

The x-radiation emitted by the x-ray source, however, is scattered in the object owing to inevitable interactions, so that, in addition to the primary beams, the detector also receives scattered beams, so-called secondary beams. These scattered beams, which, depending on properties of the object, can cause up to 90% or more of the-total signal response of an x-ray detector in diagnostic images, constitute an additional noise source and therefore reduce the identifiability of fine contrast differences. This substantial disadvantage of scattered radiation is due to the fact that, owing to the quantum nature of the scattered radiation, a significant additional noise component is induced in the image recording.

In order to reduce the scattered radiation components striking the detectors, so-called anti-scatter grids are therefore interposed between the object and the detector. Anti-scatter grids include regularly arranged structures that absorb the x-radiation, between which transmission channels or transmission slits for minimally attenuated transmission of the primary radiation are formed. These transmission channels or transmission slits, in the case of focused anti-scatter grids, are aligned with the focus of the x-ray tube according to the distance from the point x-ray source, that is to say the distance from the focus. In the case of unfocused anti-scatter grids, the transmission channels or transmission slits are oriented perpendicularly to the surface of the anti-scatter grid over its entire area. However, this leads to a significant loss of primary radiation at the edges of the image recording, since a sizeable part of the incident primary radiation strikes the absorbing regions of the anti-scatter grid at these points.

In order to achieve a high image quality, very stringent requirements are placed on the properties of x-ray anti-scatter grids. The scattered beams should, on the one hand, be absorbed as well as possible while, on the other hand, the highest possible proportion of primary radiation should be transmitted unattenuated through the anti-scatter grid. It is possible to achieve a reduction of the scattered beam component striking the detector surface by a large ratio of the height of the anti-scatter grid to the thickness or the diameter of the transmission channels or transmission slits, that is to say by a high aspect ratio.

The thickness of the absorbing structure elements or wall elements lying between the transmission channels or transmission slits, however, can lead to image perturbations by absorption of part of the primary radiation. Specifically when solid-state detectors are used, inhomogeneities of the grids, that is to say deviations of the absorbing regions from their ideal position, cause image perturbations by projection of the grids in the x-ray image. For example, in the case of matricially arranged detector elements, there is the risk of the projection of the structures of detector elements and anti-scatter grids mutually interfering. Perturbing moire phenomena can thereby arise.

A particular disadvantage of all known anti-scatter grids is that the absorbing structure elements cannot be made arbitrarily thinly and precisely, so that a significant part of the primary radiation is always removed by these structure elements.

The same problem occurs in nuclear medicine, especially when using gamma cameras, for example Anger cameras. With this recording technique also, as with x-ray diagnosis, it is necessary to ensure that the fewest possible scattered gamma quanta reach the detector.

In contrast to x-ray diagnosis, the radiation source for the gamma quanta lies inside the object in the case of nuclear diagnosis. In this case, the patient is injected with a metabolic preparation labeled with particular unstable nuclides, which then becomes concentrated in a manner specific to the organ.

By detecting the decay quanta correspondingly emitted from the body, a picture of the organ is then obtained. The profile of the activity in the organ as a function of time permits conclusions about its function. In order to obtain an image of the body interior, a collimator that sets the projection direction of the image needs to be placed in front of the gamma detector.

In terms of functionality and structure, such a collimator corresponds to the anti-scatter grid in x-ray diagnosis. Only the gamma quanta dictated by the preferential direction of the collimator can pass through the collimator, and quanta incident obliquely to it are absorbed in the collimator walls. Because of the higher energy of gamma quanta compared with x-ray quanta, collimators need to be made many times higher than anti-scatter grids for x-radiation.

For instance, scattered quanta may be deselected during the image recording by taking only quanta with a particular energy into account in the image. However, each detected scattered quantum entails a dead time in the gamma camera of, for example, one microsecond, during which no further events can be registered. Therefore, if a primary quantum arrives shortly after a scattered quantum has been registered, it cannot be registered and it is lost from the image. Even if a scattered quantum coincides temporally—within certain limits—with a primary quantum, a similar effect arises.

Since the evaluation electronics can then no longer separate the two events, too high an energy will be determined and the event will not be registered. Both said situations explain how highly effective scattered beam suppression leads to improved quantum efficiency in nuclear diagnosis as well. As the end result, an improved image quality is thereby achieved for equal dosing of the applied radionuclide or, for equal image quality, a lower radionuclide dose is made possible, so that the patient's beam exposure can be reduced and shorter image recording times can be achieved.

There are currently various techniques for producing anti-scatter grids for x-radiation and collimators for gamma radiation. For instance, lamellar anti-scatter grids are known, which are made up of lead and paper strips. The lead strips are used for absorption of the secondary radiation, while the paper strips lying between the lead strips form the transmission slits for the primary radiation.

However, the limited precision when producing such anti-scatter grids, as well as the fact that the thickness of the lead lamellae cannot be reduced further, entail, on the one hand, an undesired loss of primary radiation. Further, on the other hand, in the case of matricially arranged detector elements of a solid-state detector, problems in the image quality due to moire stripes and/or grid stripes.

Collimators for gamma cameras are generally produced from mechanically folded lead lamellae. This is a relatively cost-efficient solution, although it has the disadvantage that, in particular when using solid-state cameras with matricially arranged detector elements, for example in the case of cadmium-zinc telluride detectors, perturbing aliasing effects can arise because the structure of these collimators is then relatively coarse.

For producing anti-scatter grids for x-radiation, U.S. Pat. No. 5,814,235 A discloses a method in which the anti-scatter grid is constructed from individual thin metal film layers. The individual metal film layers consist of a material that strongly absorbs the x-radiation, and they are photolithographically structured with corresponding transmission holes. To that end, a photoresist needs to be applied on both sides of the respective film and exposed through a photomask. This is followed by an etching step, in which the transmission holes are etched into the film material.

After the remaining photoresist layer has been removed, an adhesion layer is applied to the etched metal films. The metal films are then positioned exactly above one another and are joined together to form the anti-scatter grid. The structure is consolidated by a subsequent heat treatment.

In this way, it is possible to produce cellular anti-scatter grids with air gaps as transmission channels, which are suitable for applications in mammography and general radiography. In this case, the photolithographic etching technique permits more; precise definition of the absorbing and nonabsorbing regions inside the anti-scatter grid than is possible with lead lamellae.

By using different masks from one metal film to another—in each case with transmission holes that are mutually offset slightly—it is also possible to produce focused anti-scatter grids by using this technique. However, an anti-scatter grid for x-radiation needs a large number of such metal film layers, which in turn require a large number of different masks and production steps. The method is therefore very time-consuming and cost-intensive.

U.S. Pat. No. 6,185,278 B1 discloses a further method for producing an anti-scatter grid for x- and gamma rays, in which individual metal films are likewise photolithographically etched and laminated above one another. In this method, however, in order to produce a focused anti-scatter grid, groups of metal film layers with exactly the same arrangement of the transmission holes are assembled together, and only the individual groups have transmission holes arranged mutually offset. This technique reduces the number of photolithographic masks necessary for producing the anti-scatter grid.

A further method for producing an anti-scatter grid for x-radiation is disclosed by U.S. Pat. No. 5,303,282. This method uses a substrate made of photosensitive material, which is exposed by using a photomask according to the transmission channels to be produced. The channels are then etched from this substrate according to the exposed regions. The surface of the substrate, as well as the inner walls of the transmission channels, are coated with a sufficient thickness of a material that absorbs the x-radiation.

In order to increase the aspect ratio, a plurality of such prepared substrates are optionally stacked above one another. Similar production techniques for producing cellular anti-scatter grids for x-radiation are described in EP 0 681 736 B1 or U.S. Pat. No. 5,970,118 A. Etching transmission channels into thicker substrates, however, leads to a loss of precision of the channel geometry.

The publication by G. A. Kastis et al., “A Small-Animal Gamma-Ray Imager Using a CdZnTe Pixel Array and a High Resolution Parallel Hole Collimator” discloses a method for producing a cellularly constructed collimator for gamma radiation. In this case as well, the collimator is produced from laminated layers of metal films, here made of tungsten, which are photochemically etched. This production method is therefore also very elaborate and cost-intensive.

Post-published DE 101 47 947 describes a method for producing an anti-scatter grid or collimator using the technique of rapid prototyping. In this method, the geometry of the transmissive and the nontransmissive regions of the anti-scatter grid or collimator is set first. Next, by way of a rapid prototyping technique through layer-wise solidification of a structural material under the action of radiation, a base body is constructed according to the geometry of the transmissive regions, and is coated with a material which strongly absorbs x- or gamma radiation on the inner surfaces of the transmission channels formed and on the front and rear surfaces. The layer thickness is selected in this case such that incident secondary radiation is virtually completely absorbed in this layer.

### SUMMARY

An object of an embodiment of the present invention resides in specifying a method for producing an anti-scatter grid or collimator that can be used to produce the anti-scatter grid or collimator with high accuracy in only a few process steps.

The anti-scatter grid or collimator, which is formed from at least one base body of prescribable geometry having transmission channels or transmission slits for primary radiation for the respective radiation type, in particular for x- and/or gamma radiation, is produced in an embodiment of the present method by forming the base body from a structural material using the injection molding technique or by means of the technique of stereolithography. In this case, a material that strongly absorbs the radiation type is directly used as structural material. This strongly absorbing structural material is preferably a composite material made from a thermoplastic and a substance that strongly absorbs the radiation type. The structural material can be, for example, a plastics material filled with tungsten powder, a plastics material filled with highly absorbing ceramic powder, or a plastics material filled with gadolinium oxysulfide.

The anti-scatter grid or collimator can be produced with only a few process steps in any desired geometry, which can be prescribed by the injection mold, by the direct formation of the base body from the material that strongly absorbs the respective radiation type, in particular x- and/or gamma radiation. Expensive assembly or etching techniques are eliminated in the same way as an additionally required coating of the base body. The same holds for the construction of the base body by means of stereolithography as a result of layerwise solidification of the structural material under the action of radiation. With these techniques, the base body can be produced in a simple way with very filigree structures and high accuracy without the need to carry out a multiplicity of expensive method steps. The entire production process up to obtaining the finished anti-scatter grid or collimator is therefore greatly simplified by contrast with other known methods of the prior art, and can be implemented cost-effectively.

In the technique of stereolithography, 3D-CAD structures, here the geometry of the base body, are converted into volumetric data in a CAD system. The 3D volumetric model for stereolithography is subsequently divided into cross sections in a computer. The cross sections have a layer thickness of 100 μm or therebelow. The original shape is constructed layer by layer after the data have been transferred onto a stereolithography system.

In an embodiment of the present method, use is made here of a technique in which the layers are constructed by the action of radiation, in particular by laser radiation. In this technique, liquid epoxy resin is preferably cured by exposure with a UV laser. The laser is focused by an optical lens and scanner system and guided over the surface to be cured.

The shape of the component is traced with the laser on the resin surface by way of the 3D volumetric data and cured in this way. After the curing, a new layer is applied, or the component with the cured region is lowered by one layer thickness, the new layer is exposed, etc. The entire process is repeated layer by layer until the component has its complete contour.

According to an embodiment of the present invention, a stereolithography system with a construction area of 250×250 mm² can be used to produce an anti-scatter grid or collimator. A particular feature in the case of the use of the technique of stereolithography for producing the anti-scatter grid or collimator may reside in the plastics material being provided with a filling material which ensures that the base body absorbs a high level of radiation. Gadolinium oxysulfide (GOS), high absorbing ceramic powder or tungsten powder, for example, can be used here as filling material. This filling material may be permanently incorporated into the base body upon solidification of the plastics material.

In a further possible technique of stereolithography, which is also known by the term of “solid ground curing”, the structure of each layer may be applied to a glass substrate as a negative mask by the graphics generator. The mask serves as lithographic structure and may be removed and reapplied after each exposure. A thin layer of a UV-curing resin that is provided with the filling materials may be applied to a working plate. This is followed by exposure with UV light through the mask such that the structures below the mask are cured. The unexposed regions remain liquid and are evacuated.

The cavities produced may be filled up with hot, liquid wax that is subsequently cured. Finally, the surface of the newly fabricated layer may be milled flat. After the production of this layer, a new layer of resin can be applied and be selectively solidified in the same way. The entire process may then be continued until the complete component has been finished.

In one refinement of an embodiment of the present method, the anti-scatter grid or collimator may be assembled not from a single base body, but from a number thereof. These base bodies are arranged next to one another or stacked one upon another in the passing direction of the radiation. The assembly of the anti-scatter grid or collimator from a number of base bodies is advantageous in order to ensure an adequate mechanical stability of the webs, in particular when there is a need for a small web width, that is to say a short distance between the transmission channels or transmission slits in the case of a large web length.

The geometry of the base body can be provided as desired in the case of at least one embodiment of the present method. An embodiment of the present method may be used to form a focused anti-scatter grid or collimator in which the slope of the bounding walls of the transmission holes or transmission slits is aligned with a specific x-ray focal position. It may be advantageous, furthermore, to provide the anti-scatter grid or collimator not only with transmission slits, but with a matricial arrangement of transmission channels such that a cellular or honeycomb structure is produced. It is possible in this way also to achieve collimation in the second dimension, in particular in the z-direction of an x-ray system.

### BRIEF DESCRIPTION OF THE DRAWINGS

The present method will be explained again briefly below with the aid of example embodiments in conjunction with the drawings, in which:

FIG. 1 schematically shows the action of an anti-scatter grid when recording x-ray images of an object;

FIG. 2 schematically shows the situation when using a collimator during the nuclear medical recording of an object;

FIG. 3 shows a representation to illustrate the technique of stereolithography;

FIG. 4 shows a representation to illustrate the injection molding technique;

FIG. 5 shows a first example of a collimator or anti-scatter grid produced using an embodiment of the present method; and

FIG. 6 shows a second example of an anti-scatter grid or collimator produced using an embodiment of the present method.

### DETAILED DESCRIPTION OF THE EXAMPLE EMBODIMENTS

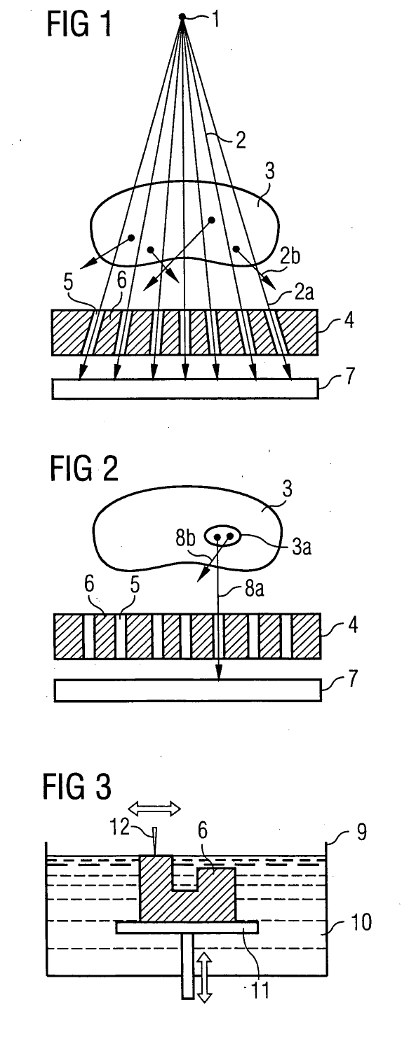

The typical situation when recording an x-ray image of an object 3 in x-ray diagnosis is represented schematically with the aid of FIG. 1. The object 3 lies between the tube focus 1 of an x-ray tube, which may be regarded as an approximately point x-ray source, and a detector surface 7. The x-rays 2 emitted from the focus 1 of the x-ray source propagate in a straight line in the direction of the x-ray detector 7, and in doing so pass through the object 3.

The primary beams 2a striking the detector surface 7, which pass through the object 3 on a straight line starting from the x-ray focus 1, cause, on the detector surface 7, a positionally resolved attenuation value distribution for the object 3. Some of the x-rays 2 emitted from the x-ray focus 1 are scattered in the object 3. The scattered beams 2b created in this case do not contribute to the desired image information and, when they strike the detector 7, they significantly impair the signal-to-noise ratio.

In order to improve the image quality, an anti-scatter grid 4 is therefore arranged in front of the detector 7. This anti-scatter grid 4 has transmission channels 5 in a base body 6 which in this case consists of a material nontransmissive to x-radiation. The transmission channels 5 are aligned in the direction of the tube focus 1, so that they allow the incident primary radiation 2a on a straight-line path to strike the detector surface. Beams not incident in this direction, in particular the scattered beams 2b, are blocked or significantly attenuated by the absorbing material of the base body 6.

However, on the basis of the previously known production techniques, the absorbing intermediate walls of the base body 6 can be implemented only with a particular minimum thickness. As such, a significant part of the primary radiation 2a is therefore also absorbed and does not contribute to the image result.

FIG. 2 shows the situation when recording images in nuclear diagnosis. The body 3 to be examined, in which an organ 3a is indicated, can be seen in the figure. By injection of a medium which emits gamma radiation, and which concentrates in the organ 3a, gamma quanta 8a are emitted from this region and strike the detector 7, an Anger camera. By way of the collimator 4 arranged in front of the detector 7, which has transmission channels 5 aligned in a straight line between regions of the base body 6 that absorb gamma radiation, the projection direction of the respective image recording is set. Gamma quanta 8b which are emitted in other directions or are scattered, and which do not arrive on a straight-line path from this projection direction, are absorbed by the collimator 4. In this technique as well, however, a significant part of the primary radiation 8a is still absorbed because the absorbing regions of the base body 6 are not arbitrarily thin.

An embodiment of the present invention provides a method which permits very precise fabrication of anti-scatter grids or collimators with thin webs or intermediate walls between the transmission channels 5. In this case, in one refinement of the method the anti-scatter grid or collimator is produced by using the technique of stereolithography as it is illustrated with the aid of the representation in FIG. 3, by way of example. With this technique, a UV laser beam 12 is directed onto the surface of a liquid UV-crosslinkable polymer 10 that is located in a container 9. Using a three-dimensional volumetric model of the base body 6 to be produced, the UV laser beam 12 moves over the surface of the liquid polymer 10 in order to construct the base body 6 in a layerwise fashion.

After the solidification of a layer, the latter is lowered via a construction platform 11 by a further layer thickness such that the UV laser 12 can solidify the next layer in accordance with the three-dimensional volumetric model. The base body 6 is constructed in this way layer by layer from the crosslinked UV-cured polymer 10, which is provided in the case of the present method with filling substances made from a material that strongly absorbs x-radiation.

Use may be made as structural material, for example, of a UV-curing polymer with a filling of tungsten powder. Because the UV laser beam 12 can be effectively focused, it is possible thereby to implement very filigree structures with very high accuracy. The base body 6 can be constructed directly on the construction platform 11 or on an additional carrier plate (not illustrated in the figure) that lies on the construction platform 11. Furthermore, it is also possible to use the technique of stereolithography for the direct construction of a base plate on which the base body 6 is then formed in accordance with the desired geometry.

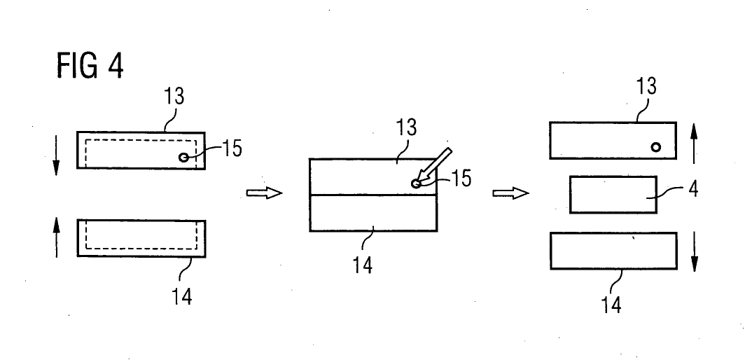

FIG. 4 shows by way of example a mode of procedure when the injection molding technique is used to produce a base body. In this technique, an upper injection mold 13 and a lower one 14 are prepared which, when assembled, form the negative mold for the base body of the anti-scatter grid or collimator 4. Such injection molds can be produced in a known way by molding or by way of a rapid prototyping technique.

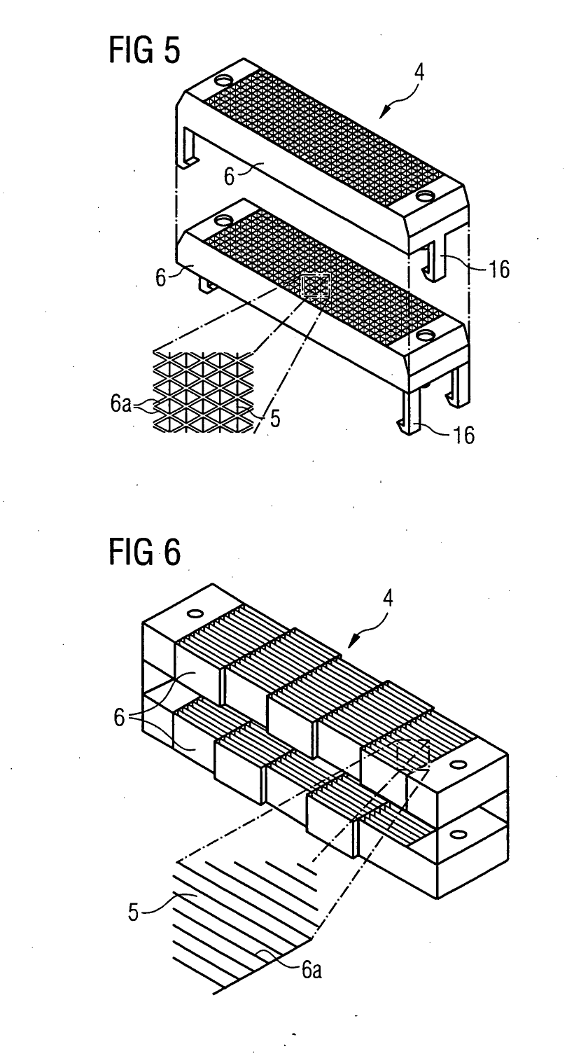

After the joining of the two part molds 13, 14, the liquefied structural material is injected via the injection opening 15 into the cavity formed between the part molds 13, 14. The two part molds 13, 14 are separated from one another again after the solidification of this structural material. The anti-scatter grid or collimator 4 formed in this way can, for example, have a structure such as to be seen in the following examples of FIGS. 5 and 6.

The plastics material, for example ECOMASS® or an epoxy resin with a filling of tungsten powder, used in this case leads to an adequate absorption of radiation by the webs between the transmission channels of the base body. Further examples of filling substances are Co-60 and N-16, with the aid of which a higher shielding performance than that of lead can be achieved.

FIG. 5 shows a first example of an anti-scatter grid or collimator 4 that can be produced using an embodiment of the present method. Two base bodies 6 that can be stacked one above another are illustrated in the present example. These base bodies 4 are provided for fastening with snap latches 16 that permit the two base bodies 6 to be permanently connected simply and releasably.

These base bodies have a multiplicity of transmission channels 5, as may be seen from the enlarged section of the figure. The webs 6a that run in transverse and longitudinal fashion and bound the transmission channels 5 form a cellular anti-scatter grid or collimator with which collimation is achieved both in the φ-direction and in the z-direction.

FIG. 6 shows a further example of a stacked construction of a collimator or anti-scatter grid 4 that can be produced using the method of an example embodiment. The two base bodies 6 that can be stacked one above another are also to be seen in this figure in a fashion spaced apart. Here, the base bodies each have a multiplicity of transmission slits 5 that are arranged in parallel and are spaced apart from one another in each case by longitudinally running webs 6a. An enlarged plan view is to be seen, in turn, in the lower left-hand part of the figure.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for producing at least one of an anti-scatter grid and collimator for a radiation type, formed from at least one base body of prescribable geometry having at least one of transmission channels and transmission slits for primary radiation of the radiation type which extend between two opposite surfaces of the base body, the method comprising:
forming the base body from a structural material that strongly absorbs the radiation type, using a technique of stereolithography.

2. The method as claimed in claim 1, wherein a composite material made from a thermoplastic and a substance that strongly absorbs the radiation type is used as the structural material.

3. The method as claimed in claim 1, wherein at least one of a plastic and a ceramic material that are filled with a substance that strongly absorbs the radiation type is used as the structural material.

4. The method as claimed in claim 1, wherein a plastics material filled with tungsten powder is used as the structural material.

5. The method as claimed in claim 1, wherein a plastics material filled with highly absorbing ceramic powder is used as the structural material.

6. The method as claimed in claim 1, wherein a plastics material filled with gadolinium oxysulfide is used as the structural material.

7. The method as claimed in claim 1, wherein the at least one of an anti-scatter grid and collimator is assembled from a number of base bodies.

8. The method as claimed in claim 7, wherein the base bodies are stacked one upon another such that their surfaces are situated opposite one another.

9. The method as claimed in claim 1, wherein the geometry of the base body is prescribed in such a way that a focused at least one of an anti-scatter grid and collimator is formed.

10. The method as claimed in claim 1, wherein the geometry of the base body is prescribed in such a way that the transmission channels format least one of an anti-scatter grid and collimator with a cellular structure.

11. The method as claimed in claim 1, for producing an anti-scatter grid for x-radiation.

12. The method as claimed in claim 1, for producing a collimator for gamma radiation.

13. A method for producing at least one of an anti-scatter grid and collimator, comprising:
forming a base body, including at least one of transmission channels and transmission slits for radiation, from a structural material that strongly absorbs the radiation, wherein the forming is achieved using a technique of stereolithography.

14. (canceled)

15. The method as, claimed in claim 13, wherein a composite material made from a thermoplastic and a substance that strongly absorbs the radiation type is used as the structural material.

16. The method as claimed in claim 13, wherein at least one of a plastic and a ceramic material that are filled with a substance that strongly absorbs the radiation type is used as the structural material.

17. The method as claimed in claim 13, wherein a plastics material filled with tungsten powder is used as the structural material.

18. The method as claimed in claim 13, wherein a plastics material filled with highly absorbing ceramic powder is used as the structural material.

19. The method as claimed in claim 13, wherein a plastics material filled with gadolinium oxysulfide is used as the structural material.

20. The method as claimed in claim 13, wherein the at least one of an anti-scatter grid and collimator is assembled from a number of base bodies.

21. The method as claimed in claim 20, wherein the base bodies are stacked one upon another such that their surfaces are situated opposite one another.
